(19) United States
(12) Patent Application Publication
(10) Pub. No.: US 2007/0182313 A1
(43) Pub. Date: Aug. 9, 2007

(54) METHOD OF MANUFACTURING IMAGE DISPLAY UNIT, AND IMAGE DISPLAY UNIT

(76) Inventors: Akiyoshi NAKAMURA, Saitama-shi (JP); Tomoko Kozuka, Hiratsuka-shi (JP); Akira Mikami, Hiratsuka-shi (JP); Takeo Ito, Kumagaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/669,993

(22) Filed: Feb. 1, 2007

Related U.S. Application Data
(63) Continuation of application No. PCT/JP05/14035, filed on Aug. 1, 2005.

(30) Foreign Application Priority Data
Aug. 3, 2004 (JP) 2004-226918

(51) Int. Cl. H01J 63/04

(52) U.S. Cl. 313/496

(57) ABSTRACT

A method of manufacturing an image display unit comprising forming a light-shielding layer by patterning on a front-side substrate opposed to a back-side substrate on which a number of electron emission elements are arranged, forming a plurality of fluorescent layer as a discontinuous pattern at intervals in an area where the light-shielding layer does not exist, and forming a metal back layer having an anode function on a top face of the fluorescent layer.

### CROSS-REFERENCE TO RELATED APPLICATIONS

This is a Continuation Application of PCT Application No. PCT/JP2005/014035, filed Aug. 1, 2005, which was published under PCT Article 21(2) in Japanese.

This application is based upon and claims the benefit of priority from prior Japanese Patent Application No. 2004-226918, filed Aug. 3, 2004, the entire contents of which are incorporated herein by reference.

### BACKGROUND OF THE INVENTION

1. Field of the Invention

The present invention relates to a method of manufacturing an image display unit, and an image display unit. In particular, the invention relates to a method of manufacturing a flat image display unit using an electron emission element.

2. Description of the Related Art

A flat image display unit has been developed as a next-generation image display unit in recent years. In the flat image display unit, a number of electron emission elements are arranged to be opposite to a fluorescent plane. An electron emission element is available in various types, and is basically a field emission type. A display unit using such an electron emission element is generally called a field emission display (called a FED hereinafter). As a type of FED, a display unit using a surface-conduction electron-emitter is also called a surface-conduction electron-emitter display (called a SED hereinafter). In this specification, the term FED is used as a generic name of FED including SED.

To obtain practical display characteristics of FED, it is necessary to use a fluorescent member similar to an ordinary cathode-ray tube, and to use a fluorescent plane made by forming an aluminum thin film called a metal back on a fluorescent member. In this case, an anode voltage applied to a fluorescent plane is at least several kV, desirably 10 kV or higher.

However, a clearance between a front-side substrate and a back-side substrate of FED is limited from the viewpoint of resolution and characteristics of a support member, and needs to be set to 1-2 mm. Thus, in FED, a strong electric field is formed in a narrow space between a front-side substrate and a back-side substrate, and when an image is formed for a long time, an electric discharge (a surface discharge between metal back films, a vacuum arc discharge) is likely to occur between the substrates. Once an electric discharge occurs, a large discharge current of several amperes to several hundreds amperes flows in a moment, and an electron emission element of a cathode and a fluorescent plane of an anode may be damaged or destroyed. Such an electric discharge causing a defect should not be allowed as a product. Therefore, for practical use of FED, it is necessary to prevent damages caused by an electric discharge for a long period.

Jpn. Pat. Appln. KOKAI Publication No. 10-326583 discloses the technique, which divides a metal back layer used as an anode and connects a divided layer to a common electrode provided outside a fluorescent plane, in order to weaken damages when an electric discharge occurs.

However, in the above prior art, a process of dividing a formed metal back film is necessary, and productivity is decreased and cost is increased. Further, in a process of dividing a metal back film, there is a possibility that a fluorescent layer as a base layer is damaged.

### BRIEF SUMMARY OF THE INVENTION

It is an object of the present invention to provide a method of manufacturing an image display unit with high productivity and quality at low cost, while controlling a surface discharge between metal back films, and an image display unit manufactured by the method.

A method of manufacturing an image display unit comprising: forming a light-shielding layer by patterning on a front-side substrate opposed to a back-side substrate on which a number of electron emission elements are arranged; forming a plurality of fluorescent layer as a discontinuous pattern at intervals in an area where the light-shielding layer does not exist; and forming a metal back layer having an anode function on a top face of the fluorescent layer.

An image display unit comprising: a light-shielding layer formed by patterning on a front-side substrate opposed to a back-side substrate on which a number of electron emission elements are arranged; a plurality of fluorescent layer formed as a discontinuous pattern at intervals in an area where the light-shielding layer does not exist; and a metal back layer having an anode function formed on a top face of the fluorescent layer.

The above fluorescent layer is formed by arranging several kinds of fluorescent segment including a different fluorescent substance in a predetermined repetitive pattern. These fluorescent segments are shaped rectangular or like rectangular strips, and at least the same kind of segments (e.g. red (R) and red (R)) are arranged as a discontinuous pattern with a predetermined space. It is preferable that different kinds of segments (e.g. red (R), green (G) and blue (B)) are also arranged as a discontinuous pattern with a predetermined space.

Photolithography may be any one of a wet process or a dry process. A wet process is preferable. In an optimum wet process, fluorescent particles are mixed in a photoresist solution (containing a solvent) at a predetermined ratio, the mixed solution is coated on a front-side substrate by a spin coating method, a bar coater method or a roll coater method, the coated surface is heated for drying, exposed, developed and finally baked to eliminate a photoresist, and a fluorescent layer of a predetermined pattern is obtained. A screen printing method may also be used for forming a fluorescent layer. When forming a color fluorescent plane, repeat photolithography three times for each of red (R), green (G) and blue (B), and form a 3-color pattern of rectangular or rectangular strip shaped fluorescent pixels arranged regularly in vertical and horizontal directions.

A metal back layer is formed just like covering the top face of a fluorescent layer, but not formed on a sidewall of a fluorescent layer. Therefore, conduction between adjacent fluorescent layer patterns is prevented in a state that a film is being formed without using a dividing step after a film is formed, and an electric discharge can be effectively prevented. The width of a vertical partition line dividing rectangular or rectangular strip shaped fluorescent pixels is 20-50 μm, and the width of a horizontal partition line (stripe) is 50-300 μm. These widths of vertical and horizontal partition lines indicate intervals at the bottom of a fluorescent layer regardless of a sectional form (rectangular, trapezoidal, inverse trapezoidal) of a fluorescent layer.

The thickness of a fluorescent layer depends on a coating thickness and a diameter of a fluorescent particle, and usually 7-10 μm. A fluorescent element such as ZnS, Y₂O₃, and Y₂O₂S groups used generally for CRT of a color TV can be used for a fluorescent layer. A fluorescent element for CRT of a color TV shows good brightness and color reproduction when an electron accelerated by a voltage of several kV-several 10 kV I is applied, and has high luminance though the price is relatively low.

In the present invention, a fluorescent layer can be formed as a fine and precise pattern by photolithography. A corresponding metal back layer can also be formed as a fine and precise pattern by photolithography. The thickness of a metal back layer is usually in a range of 50-200 nm (0.05-0.2 μm).

### BRIEF DESCRIPTION OF THE SEVERAL VIEWS OF THE DRAWING

FIG. 1A is a process drawing showing a method of manufacturing an image display unit according to an embodiment of the invention;

FIG. 1B is a process drawing showing a method of manufacturing an image display unit according to an embodiment of the invention;

FIG. 1C is a process drawing showing a method of manufacturing an image display unit according to an embodiment of the invention;

FIG. 2 is a perspective view showing an outline of an image display unit (FED);

FIG. 3 is a sectional view taken along lines A-A of FIG. 2;

FIG. 4 is a partially broken away plan view showing a fluorescent plan and a metal back layer of a front-side substrate of an image display unit (FED);

FIG. 5 is a partially enlarged plan view showing an image display unit according to an embodiment of the invention;

FIG. 6 is a sectional view taken along lines B-B of FIG. 5; and

FIG. 7 is a sectional view taken along lines C-C of FIG. 5.

### DETAILED DESCRIPTION OF THE INVENTION

Best mode of the invention will be explained hereinafter with reference to the accompanying drawings.

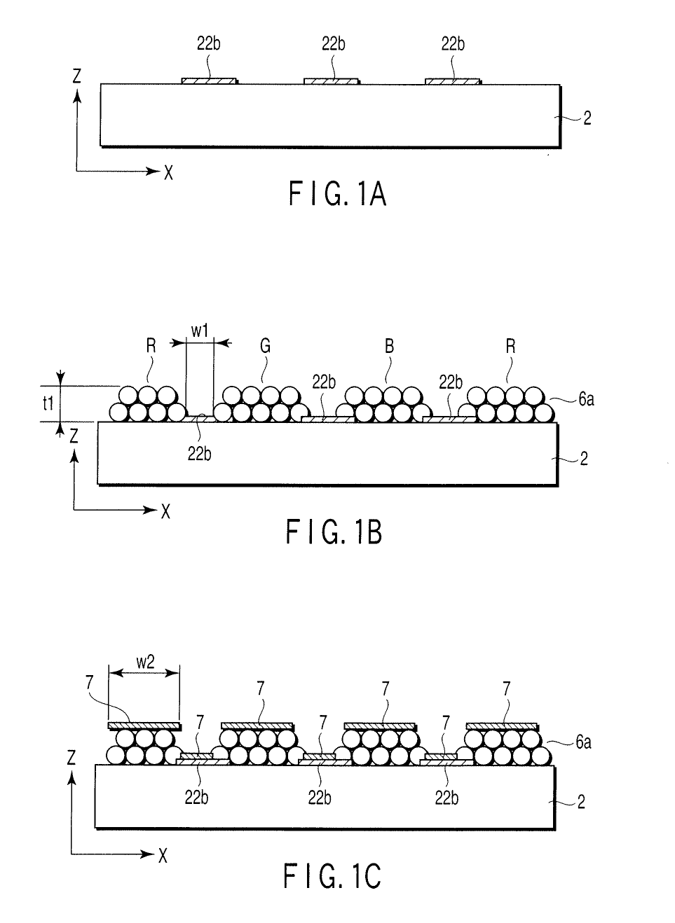

An explanation will be given on a method of manufacturing FED as an image display unit according to an embodiment of the invention with reference to FIG. 1.

Clean a glass substrate 2 as a front-side substrate of FED with a predetermined chemical solution, and obtain a desired clean surface. Coat the inside of the cleaned front-side substrate 2 with a light-shielding layer forming solution including a light-absorbing substance such as a black pigment. Heat and dry the coated film. Expose the film through a screen mask having apertures at positions corresponding to a matrix pattern. Develop the obtained latent image, and forms a matrix pattern of light-shielding layers 22b as shown in FIG. 1A.

Coat the surface of the front-side substrate 2 to a predetermined thickness with a mixed solution prepared by mixing red (R) fluorescent particles in a photoresist solution (containing a solvent) at a predetermined ratio by a spin coating method. Heat and dry the coated film. Expose, and develop the film through a screen mask having an aperture at a position corresponding to a red (R) pattern. As for green (G) and blue (B), form a predetermined pattern by the same photolithography. Finally, bake the substrate 2 to eliminate a photoresist, and obtain a fluorescent plane having a fluorescent layer 6a with three color rectangular patterns arranged regularly in the vertical and horizontal directions as shown in FIG. 1B. When a pixel is square with a pitch of 600 μm, for example, the width W1 in the X direction of the vertical partition line of the fluorescent layer 6a is 20-50 μm. The width W1 of the vertical partition line is defined by the intervals at the bottom of the adjacent fluorescent layers 6a regardless of a sectional form (rectangular, trapezoidal, inverse trapezoidal) of a fluorescent layer. The width in the Y direction of the horizontal partition line (stripe) of the fluorescent layer 6a is 50-300 μm. A matrix of light-shielding layers 22 exists in these vertical and horizontal partition lines to prevent leakage of light to the front-side substrate 2.

Form a metal back layer 7 on the top face of the fluorescent layer 6a with the R/G/B segment patterns. To form the metal back layer 7, form a thin film of organic resin such as nitrocellulose by a spin coating method, for example. Form an aluminum (Al) film on the formed organic resin thin film by vacuum evaporation. Finally, bake the formed film to eliminate organic substances.

As shown in FIG. 1C, the metal back layer 7 is formed on the top face of the fluorescent layer 6a and at the bottom of adjacent fluorescent layers R, G, B (i.e. the light-shielding layer 22b), respectively, but not formed on the sidewall of the fluorescent layer 6a, because development of a film on the metal back layer 7 shows anisotropy. When a pixel is square with a pitch of 600 μm, the width W2 in the X direction of the metal back layer 7 is 140-180 μm, for example.

The metal back layer 7 may be formed by using a transfer film as shown below. A transfer film is formed by alternately laminating an Al film and an adhesive layer on a base film through a mold release agent layer (a protection film if necessary). Arrange a transfer film so that an adhesive layer contacts a fluorescent layer, and press the film by a stamp method or a roller method. After pressing the transfer film and bonding the Al film, peel off the base film. The Al film is transferred only to the top face of the fluorescent layer 6a.

Place the fluorescent plane 6 formed as above within a vacuum enclosure together with an electron emission element. Use a method of forming an evacuated envelope for this purpose, namely, vacuum sealing of the front-side substrate 2 having the fluorescent plane 6 and the back-side substrate 1 having a plurality of electron emission element 8 by a flint glass, for example. Further, evaporate a predetermined getter material on a pattern in the vacuum enclosure, and form an evaporated film in an area of the metal back layer 7.

In a FED made by the above method, the space between the front-side substrate 2 and back-side substrate 1 is very narrow, and an electric discharge (dielectric breakdown) is likely to occur. Contrarily, in a FED formed by the method of this embodiment, the metal back layer 7 is divided for each pixel segment by the fluorescent layer 6a formed as a pattern while holding the metal back layer as a film. Therefore, even if an electric discharge occurs, a peak value of discharging current is controlled, and momentary concentration of energy is avoided. As a result of decreasing a maximum value of discharging energy, destruction, damages and degradation of an electron emission element and a fluorescent plane are prevented.

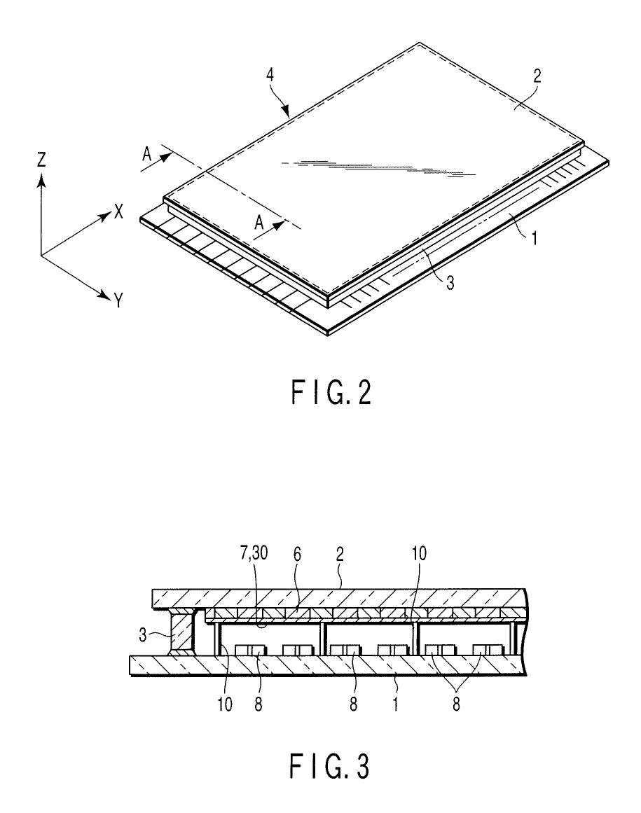

FIG. 2 and FIG. 3 show the structure of FED common to this embodiment. FED has a front-side substrate 2 and a back-side substrate 1, which are made of square glass and opposed at an interval of 1-2 mm. These front-side substrate 2 and back-side substrate 1 are joined in their peripheral edge portions through a rectangular frame-like sidewall, constituting a flat rectangular vacuum enclosure whose inside is kept in a high vacuum of approximately 10⁻⁴ Pa.

A fluorescent plane 6 is formed on the inside surface of the front-side substrate 2. The fluorescent plane 6 consists of a fluorescent layer 6a which emits three colors of red (R), green (G) and blue (B), and a matrix-like light-shielding layer 22b. A metal back layer 7 which functions as an anode and as a light reflection film to reflect the light from the fluorescent layer 6a, is formed on the fluorescent plane 6. Under the displaying operation, the metal back layer 7 is supplied with a predetermined anode voltage from a not-shown circuit.

A number of electron emission element 8 which emits an electron beam to excite the fluorescent layer 7, is provided on the inside surface of the back-side substrate 1. These electron emission elements 8 are arranged in several columns and rows corresponding to each pixel. The electron emission elements 8 are driven by a not-shown wiring arranged like a matrix. Between the back-side substrate 1 and front-side substrate 2, a number of plate-like or column-like spacers 10 are provided as reinforcements to withstand an atmospheric pressure acting on the substrates 1 and 1.

An anode voltage is applied to the fluorescent plane 6 through the metal back layer 7. An electron beam emitted from the electron emission element 8 is accelerated by the anode voltage, and collides against the fluorescent plane 6. The corresponding fluorescent layer 6a emits light, and an image is display.

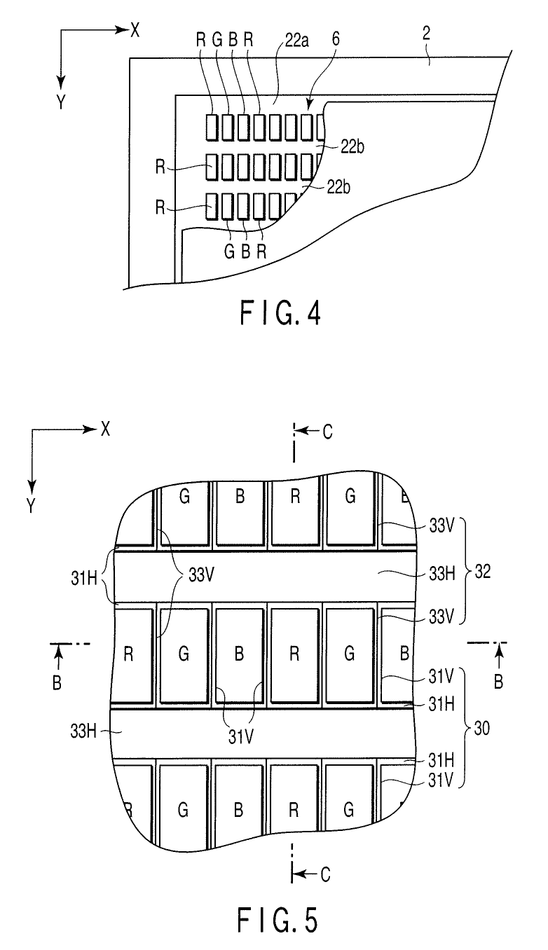

FIG. 4 shows the structure of the front-side substrate 2, particularly, the fluorescent plane 6 common to the embodiments of the invention. The fluorescent plane 6 has a number of rectangular fluorescent layers to emit red (R), green (G) and blue (B) light. Taking the longish side of the front-side substrate 2 as an X-axis and the width side orthogonal to the longish side as a Y-axis, the fluorescent layers R, G and B are repeatedly arranged with a predetermined gap in the X-axis direction, and the fluorescent layer of the same color is repeatedly arranged with a predetermined gap. A predetermined gap is allowed to fluctuate within an error range in manufacturing or within a tolerance range in designing, and a gap among the fluorescent layers 6a cannot be said a constant value in the XY plane, but it is considered almost a constant value for convenience of explanation.

The fluorescent plane has a light-shielding layer 22. The light-shielding layer 22 has a rectangular frame light-shielding layer 22a extending along the peripheral edge of the front-side substrate 2, and a matrix pattern of light shielding layers 22b extending like a matrix among the fluorescent layers R, G and B, inside the rectangular fame light-shielding layer 22a, as shown in FIG. 4.

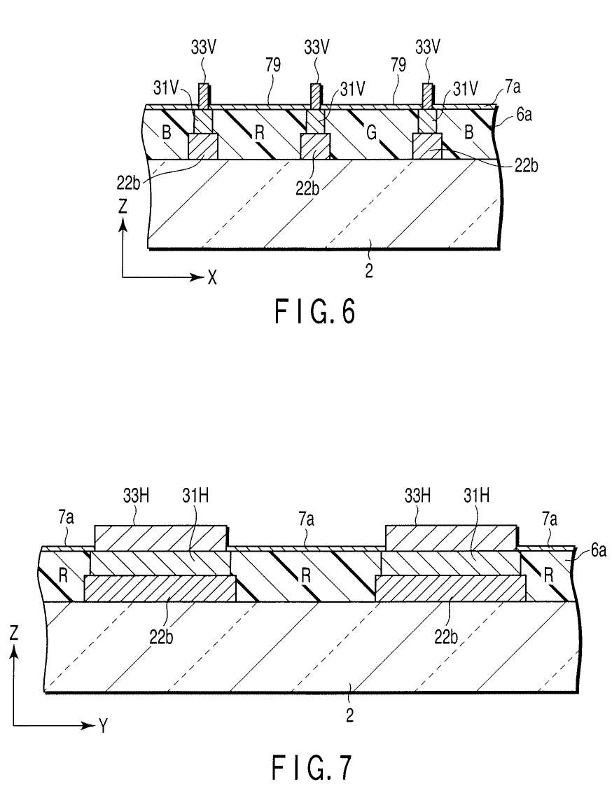

On the matrix pattern of light-shielding layers 22b, there are provided a vertical line portion 31V of a resistance adjustment layer 30 extending in the Y direction as shown in FIG. 5 and FIG. 6, and a horizontal line portion 31H of a resistance adjustment layer 30 extending in the X direction as shown in FIG. 5 and FIG. 7. The vertical line portion 31V and horizontal line portion 31H are formed by ordinary photolithography by using material based on fine-grain metal oxide having a predetermined resistance. Further, a vertical line portion 33V of a dividing layer 32 is provided on the vertical line portion 31V of the resistance adjustment layer 30, and a horizontal line portion 33H of the dividing layer 32 is provided on the horizontal line portion 31H of the resistance adjustment layer 30.

The fluorescent layer 6a is arranged in the order of R, G and B in the X direction as shown in FIG. 6, and the width of the vertical line portion 31V is much narrower than the horizontal line portion 31H. When a pixel is square with a pitch of 600 μm, for example, the width of the vertical line portion 31V in the X direction is 40 μm, and the width of the horizontal line portion 31H in the Y direction is 300 μm.

According to the invention, a fluorescent layer is formed as a pattern by photolithography, and a metal back layer is laminated on the top face of a patterned fluorescent layer. Therefore, a post-process of diving a metal back layer can be omitted, and a manufacturing process is simplified. As a metal back layer dividing process is not used, a fluorescent layer as a base layer is not damaged. Of course, a surface discharge among metal back films can be prevented.

Next, embodiments of the invention will be explained.

### EMBODIMENT 1

A matrix pattern of light-shielding layers made of black pigment is formed on a glass substrate by photolithography. A fluorescent layer with a rectangular repetitive pattern of red (R), green (G) and blue (B) is formed in the space among the matrix pattern of light-shielding layers by patterning by photolithography by using Y₂O₂S:Eu³⁺ as a red (R) fluorescent body, ZnS:Cu, as a green (G) fluorescent body, and ZnS:Ag as a blue (B) fluorescent body. Finally, the substrate 2 is baked to eliminate a photoresist, and obtain a fluorescent plane with a 3-color pattern of fluorescent layers arranged regularly in the vertical and horizontal directions. A square pixel with a pitch of 600 μm is formed on the fluorescent plane, and the width W1 of the fluorescent layer in the X direction of a vertical partition line is 30 μm.

A metal back layer made of an Al film is formed on the top face of the obtained 3-color pattern of fluorescent layers by vacuum evaporation. Namely, form an organic resin layer by coating a fluorescent plane with an organic resin solution composed mainly of acrylic resin, and drying the coated surface. Form an Al film (metal back layer) on the organic resin layer by vacuum evaporation. Bake the organic resin layer at 450° C. for 30 minutes, and degrade and eliminate the organic component.

Paste composed of 5 weight % of fine-grain SiO₂ with a grain diameter of 10 nm, 4.75 weight % of ethylcellulose and 90.25 weight % of butylcarbitolacetate is screen printed on the metal back layer by using a screen mask having apertures at positions corresponding to a matrix pattern of light-shielding layers. A pattern of SiO₂ layer is formed in an area corresponding to a light-shielding layer.

Ba is evaporated in vacuum atmosphere on the SiO₂ layer having a predetermined pattern formed as above. As a result, Ba as a getter material is deposited on the SiO₂ layer, but an even film is not formed. Contrarily, an even evaporated film of Ba as a getter material is formed in the area on the Al film on which the SiO₂ layer is not formed, and as a result, a getter film of a pattern reverse to the pattern of SiO₂ layer is formed on the Al film.

FED is made by an ordinary method by using a panel having a patterned SiO₂ layer before evaporation of a getter film as a front-side substrate. A back-side substrate is made by fixing an electron generation source provided with a number of surface-conduction electron emission elements arranged like a matrix to a glass substrate. Then, the back-side substrate and front-side substrate are arranged opposite to each other through a support frame and a spacer, and sealed with a flint glass. A clearance between the back-side substrate and front-side substrate is approximately 2 mm. After vacuum discharging, Ba is evaporated to the panel surface, and a getter film of a pattern reverse to the SiO₂ layer is formed on the Al film.

Electric breakdown between patterns (surface discharge between metal back layers) in FED obtained by the embodiment 1 is examined, and a good result is obtained.

### EMBODIMENT 2

A repetitive pattern of fluorescent layers of red (R), green (G) and blue (B) is formed in the space among the light-shielding layers of a matrix pattern formed as in the embodiment 1, by patterning by photolithography by using YVO₄:Eu³⁺ as a red (R) fluorescent body, (Zn, Cd)S:Cu as a green (G) fluorescent body, and ZnS:Ag as a blue (B) fluorescent body. A square pixel with a pitch of 600 μm is formed on the fluorescent plane, and the width W1 of the fluorescent layer in the X direction of a vertical partition line is 20 μm.

A metal back layer to be provided on the top face of the fluorescent layer is formed under the same conditions of the embodiment 1. FED is made by executing a post-process under the same conditions as the embodiment 1.

Electric breakdown between patterns (surface discharge between metal back layers) in FED obtained by the embodiment 2 is examined, and a good result is obtained.

What is claimed is:

1. A method of manufacturing an image display unit comprising:
forming a light-shielding layer by patterning on a front-side substrate opposed to a back-side substrate on which a number of electron emission elements are arranged;
forming a plurality of fluorescent layer as a discontinuous pattern at intervals in an area where the light-shielding layer does not exist; and
forming a metal back layer having an anode function on a top face of the fluorescent layer.

2. The method according to claim 1, wherein the fluorescent layer is formed by photolithography.

3. The method according to claim 1, wherein the fluorescent layer has several kinds of fluorescent segments containing a fluorescent substance different to each other, and the fluorescent segments are formed as a discontinuous pattern at predetermined intervals among the same kinds and different kinds.

4. The method according to claim 1, wherein the metal back layer is formed just like covering a top face of the fluorescent layer, but not formed on a sidewall of the fluorescent layer, and conduction between adjacent fluorescent layer patterns is prevented while the layer is held as a film without using a dividing step after a film is formed.

5. An image display unit comprising:
a light-shielding layer formed by patterning on a front-side substrate opposed to a back-side substrate on which a number of electron emission elements are arranged;
a plurality of fluorescent layer formed as a discontinuous pattern at intervals in an area where the light-shielding layer does not exist; and
a metal back layer having an anode function formed on a top face of the fluorescent layer.

6. The unit according to claim 5, wherein the fluorescent layer has several kinds of fluorescent segments containing a fluorescent substance different to each other, and the fluorescent segments are formed as a discontinuous pattern at predetermined intervals among the same kinds and different kinds.
